(19) United States
(12) Patent Application Publication
(10) Pub. No.: US 2009/0202959 A1
(43) Pub. Date: Aug. 13, 2009

(54) Dental Implant Guide

(75) Inventors: Khaldoun Ajlouni, Coppell, TX (US); Raed Ajlouni, Coppell, TX (US)

Correspondence Address: BAKER BOTTS L.L.P., 2001 ROSS AVENUE, SUITE 600, DALLAS, TX, 75201-2980, US

(73) Assignee: The Texas A & M University System, College Station, TX (US)

(21) Appl. No.: 12/370,095

(22) Filed: Feb. 12, 2009

Related U.S. Application Data
(60) Provisional application No. 61/065,604, filed on Feb. 13, 2008.

(51) Int. Cl. A61C 3/02

(52) U.S. Cl. 433/76; 433/215

(57) ABSTRACT

In one embodiment of the present invention, a dental implant guide features a drill base operable to be secured inside of a human mouth. A drill guide is adjustably attached to the drill base. The drill guide is operable to guide the path of a drill bit down a drilling axis.

### RELATED APPLICATIONS

Pursuant to 35 U.S.C. § 119 (e), this application claims priority to U.S. Provisional Patent Application Ser. No. 61/065,604, filed Feb. 13, 2008. U.S. Provisional Patent Application Ser. No. 61/065,604 is hereby incorporated by reference.

### TECHNICAL FIELD

The present disclosure relates generally to the field of dental implant devices and, more particularly, to a dental implant guide.

### BACKGROUND OF THE DISCLOSURE

Dental implants are commonly used in dentistry. After a tooth is lost, a dental implant may be placed in the jaw bone and a dental prosthesis may then be placed over the implant. The dental implant may be anchored inside the mouth by drilling a hole into the jaw bone. Dental implants may restore both tooth function and tooth esthetics.

### SUMMARY OF THE DISCLOSURE

In one embodiment of the present invention, a dental implant guide features a drill base operable to be secured inside of a human mouth. A drill guide is adjustably attached to the drill base. The drill guide is operable to guide the path of a drill bit down a drilling axis.

Certain embodiments of the invention may provide numerous technical advantages. For example, a technical advantage of one embodiment may include the capability to improve the accuracy at which a dentist installs a dental implant. Other technical advantages of other embodiments may include the capability to provide a reusable dental implant guide that can be easily and instantaneously adjusted. Yet other technical advantages of other embodiments may include the capability to use a dental implant guide with a dental imaging system or surgical planning software. Still yet other technical advantages of other embodiments may include the capability to orient multiple dental implants in relation to each other.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1A shows a method of aligning and drilling a hole for placement of a dental implant according to one embodiment;

FIG. 1B shows an example of a cast of a human mouth with an open tooth socket;

FIG. 1C shows an example of a cast of a human mouth with a surgical guide positioned over an open tooth socket;

FIG. 1D shows the surgical guide of FIG. 1C positioned over an open tooth socket in a human mouth;

FIGS. 2A-2E show a dental implant guide according to one embodiment; and

FIGS. 3A, 3B, and 3C present a dental implant guide extension according to one embodiment.

### DETAILED DESCRIPTION OF EXAMPLE EMBODIMENTS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

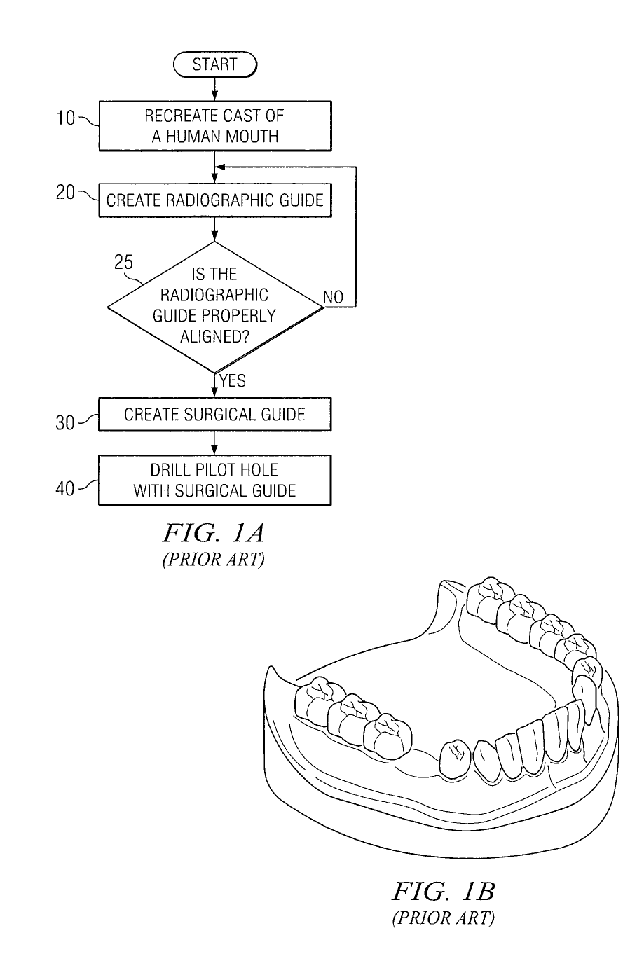

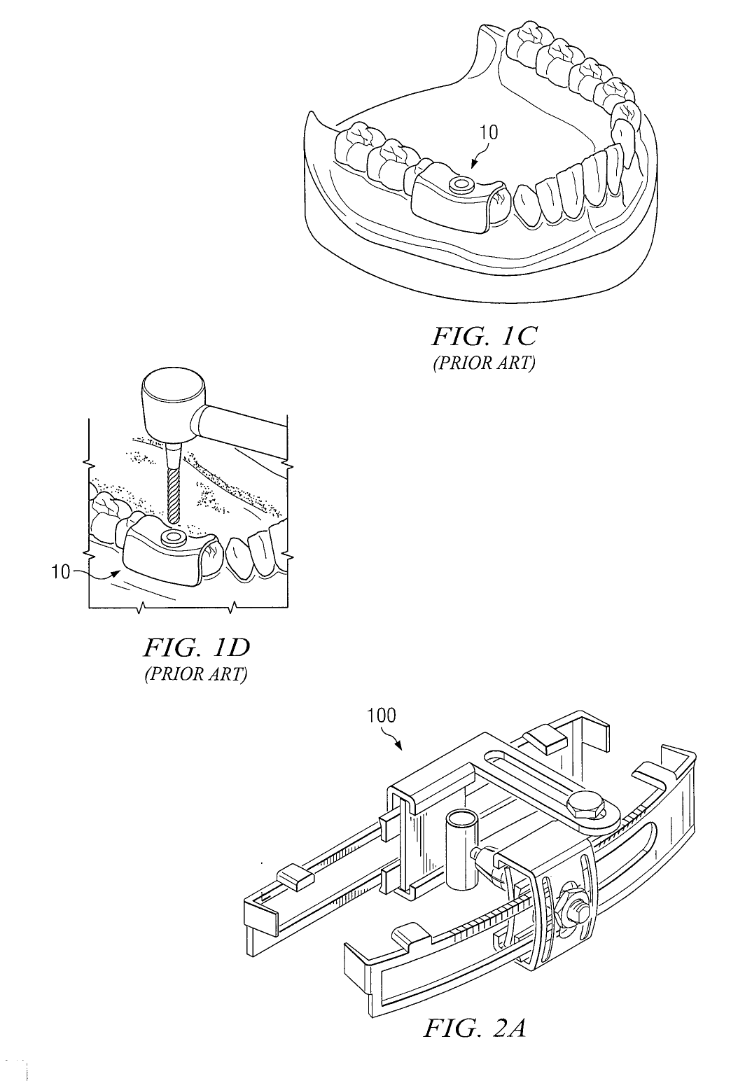

FIG. 1A shows an example of a method of aligning and drilling a hole for placement of a dental implant. At step 10, a cast of a human mouth is created. FIG. 1B shows an example of a cast of a human mouth with an open tooth socket.

At step 20, a radiographic guide is created based on the cast created at step 10. The radiographic guide represents the direction of an implant placement. The radiographic guide may include a radio-opaque material, such as a metal rod or Gutta Percha, that represents the direction of the implant placement on an x-ray.

The radiographic guide may be used to verify the correct position of the implant in relation to the jaw bone and vital anatomic structures. Teachings of certain embodiments recognize that the radiographic guide may prevent damage to critical structures such as blood vessels, nerves, and a root of an adjacent tooth because these features may not be apparent without x-rays.

At step 25, the correct position of the radiographic guide is verified. Although the radiographic guide may be constructed based on the cast, an additional patient visit may be required to verify the correct position of the radiographic guide. For example, the dentist may verify that the radiographic guide will not cause damage to critical structures such as blood vessels, nerves, and a root of an adjacent tooth. If the radiographic guide is not properly positioned, the dentist may be forced to destroy the flawed radiographic guide and create a new radiographic guide.

Once the correct position of the radiographic guide is verified, a surgical guide may be created at step 30 based on the positioning of the radiographic guide. FIG. 1C shows an example of a cast of a human mouth with a surgical guide 10 positioned over an open tooth socket. FIG. 1D shows the surgical guide 10 of FIG. 1C positioned over an open tooth socket in a human mouth. Embodiments of the surgical guide 10 may be constructed out of common materials such as acrylic or thermoplastic.

At step 40, the surgical guide 10 may be forwarded to the dentist who will place the implant. The dentist may use the surgical guide 10 to drill the hole for placement of the implant. Teachings of certain embodiments recognize that the surgical guide may provide more precise alignment of a drill bit than alignment based on sight alone.

However, the method illustrated in FIG. 1A may become complex, time consuming, error-prone, and wasteful. For example, embodiments of the surgical guide 10 made out of common materials such as acrylic or thermoplastic may only be used once. If the dentist intends to drill additional holes in preparation for the implant placement, the dentist must use multiple surgical guides 10. In addition, the radiographic guide and the surgical guide 10 cannot be modified or adjusted; rather, the method illustrated in FIG. 1A may require that a new radiographic guide or surgical guide 10 be measured and constructed.

The surgical guide 10 also may not accurately position the direction of the implant in three dimensions, and the direction is not accurately recorded or reproduced. Thus, the dentist does not have complete guidance to the final position of the implant when using the surgical guide 10. The error in location may be in several different directions and angles as compared to the implant direction identified by the radiographic guide. Furthermore, the surgical guide 10 cannot control the depth of the implant in the bone, resulting in possible damage to vital structures.

Accordingly, teachings of certain embodiments recognize the use of a dental implant guide that provides a better correlation between the intended orientation of the dental implant and the orientation at which the dental implant is installed by the dentist. Additionally, teachings of certain embodiments recognize that the dental implant guide may incorporate functionality from both the radiographic guide and the surgical guide 10. Teachings of certain embodiments recognize that producing a single dental implant guide may result in reduced errors and increased cost savings over the method of FIG. 1A. Teachings of certain embodiments also recognize the use of a reusable dental implant guide that can be easily and instantaneously adjusted.

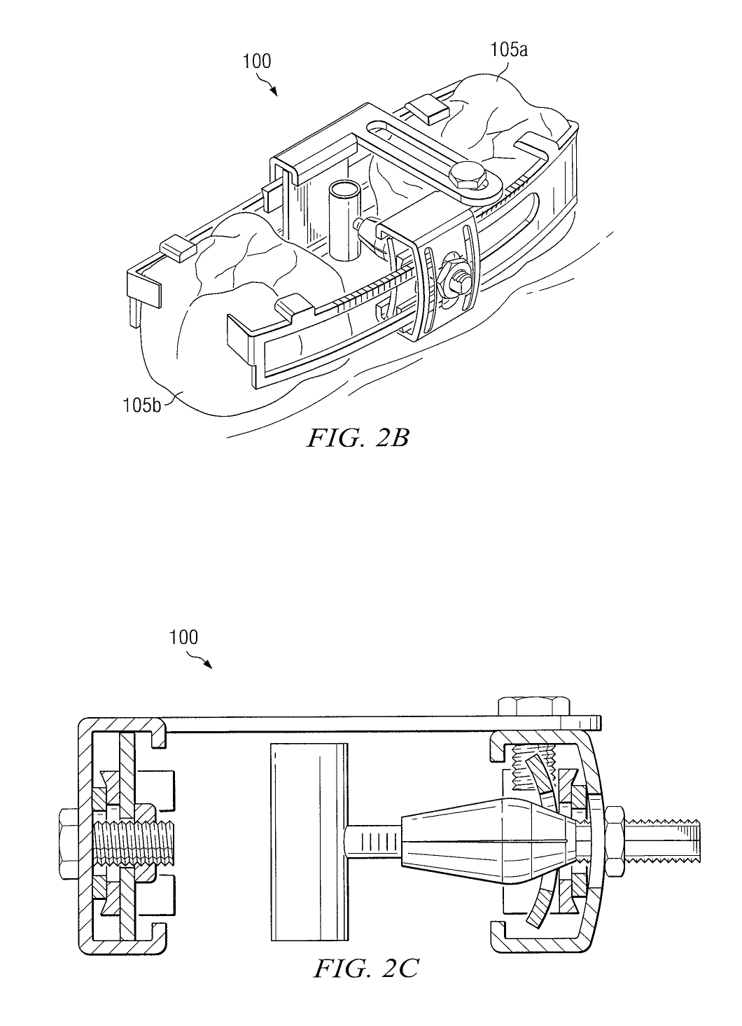

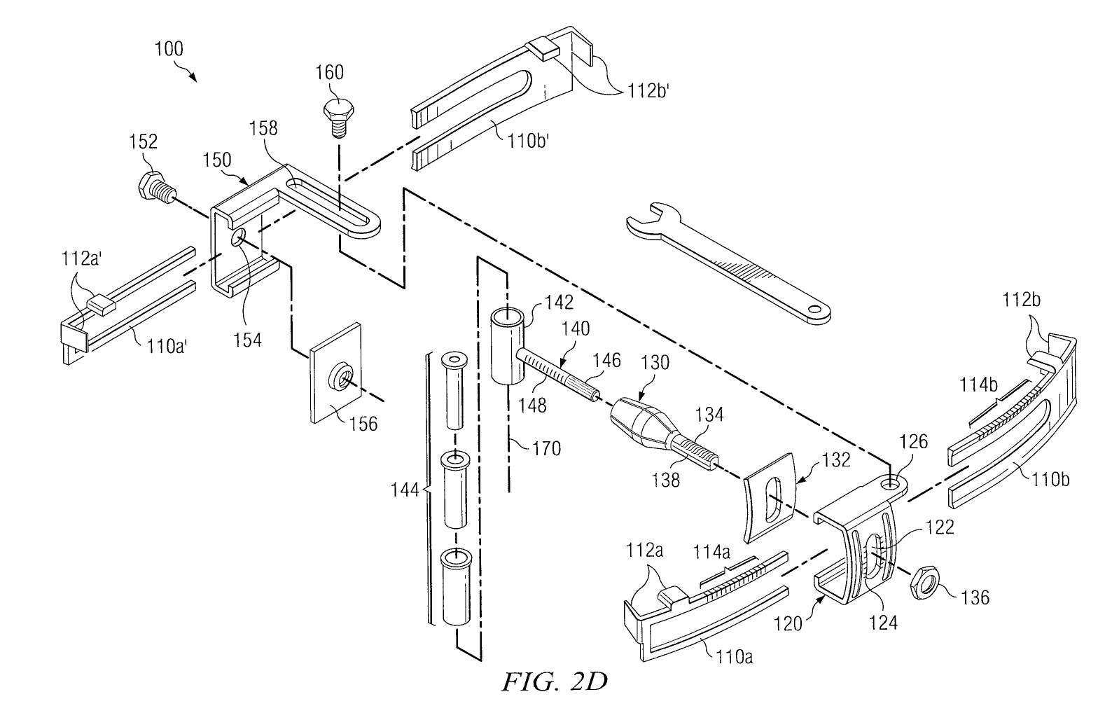

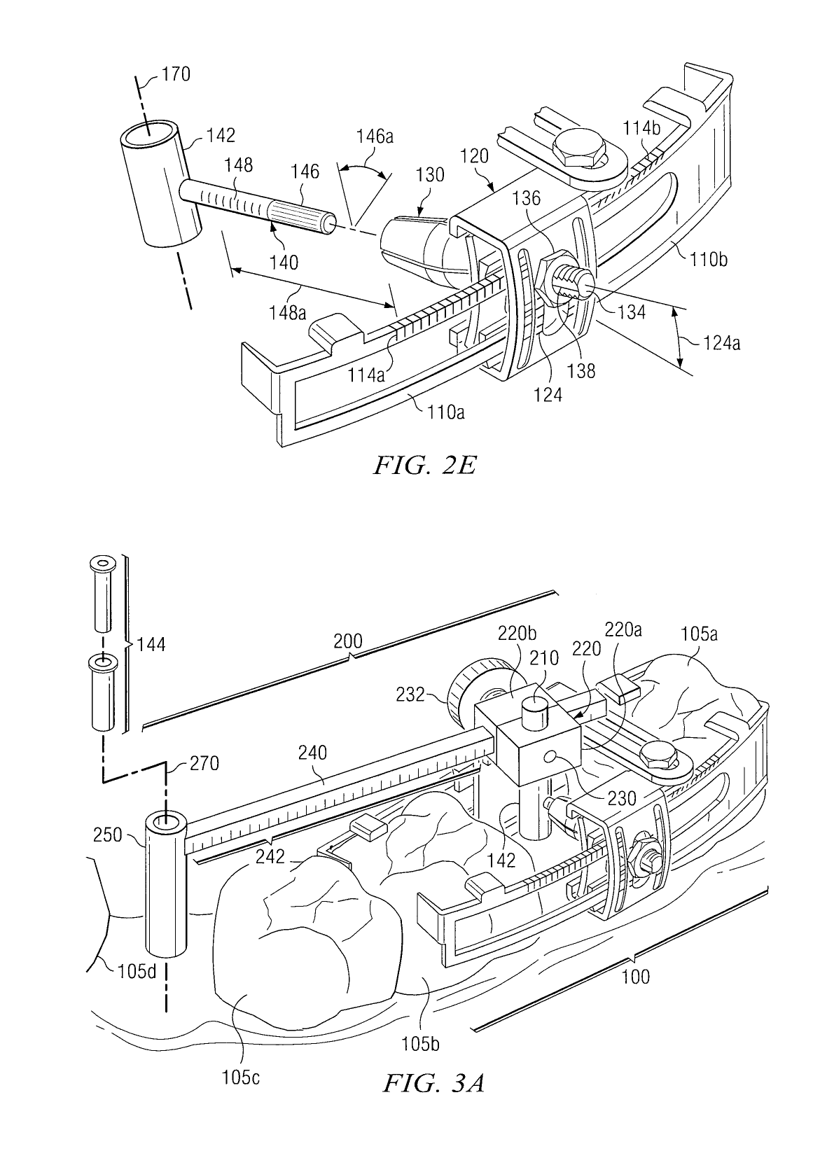

FIGS. 2A-2E show a dental implant guide 100 according to one embodiment. FIG. 2A shows a perspective view of the dental implant guide 100. FIG. 2B shows a perspective view of the dental implant guide 100 installed in an open tooth socket between two neighboring teeth 105a and 105b. FIG. 2C shows a cross-section view of the dental implant guide 100. FIG. 2D shows an assembly view of the dental implant guide 100.

In the embodiment illustrated in FIG. 2D, the dental implant guide 100 features rails 110a and 110b and tines 112a and 112b. The rails 110a and 110b may be secured together to form a single member, and the overall length of the rails 110a and 110b may be adjusted to correspond to the distance between the neighboring teeth 105a and 105b. The tines 112a and 112b hold the rails 110a and 110b to the neighboring teeth 105a and 105b. The rails 110a and 110b may be secured against the neighboring teeth 105a and 105b by shortening the overall length of the rails 110a and 110b and thus tightening the hold of the tines 112a and 112b against the neighboring teeth 105a and 105b.

The rails 110a and 110b also feature measurement lines 114a and 114b. The measurement lines 114a and 114b provide a mechanism for measuring the adjustment of the overall length of the rails 110a and 110b. In addition, the measurement lines 114a and 114b measure the position of a bracket 120 relative to the rails 110a and 110b.

In the embodiment illustrated in FIG. 2D, the dental implant guide 100 features rails 110a′ and 110b′ and tines 112a′ and 112b′. The rails 110a′ and 110b′ are positioned across the open tooth socket from the rails 110a and 110b. The rails 110a′ and 110b′ may be secured together to form a single member, and the overall length of the rails 110a′ and 110b′ may be adjusted to correspond to the distance between the neighboring teeth 105a and 105b. The tines 112a′ and 112b′ hold the rails 110a′ and 110b′ to the neighboring teeth 105a and 105b. The rails 110a′ and 110b′ may be secured against the neighboring teeth 105a and 105b by shortening the overall length of the rails 110a′ and 110b′ and thus tightening the hold of the tines 112a′ and 112b′ against the neighboring teeth 105a and 105b.

The rails 110a and 110b are held together inside the bracket 120 by a slotted plate 132. The slotted plate 132 secures the rails 110a and 110b against the bracket 120 by a bolt 134, which passes through the slotted plate 132 and an opening 122 in the bracket 120 and then fastens to a nut 136. The rails 110a′ and 110b′ are held together inside a bracket 150 by a plate 156. The plate 156 secures the rails 110a′ and 110b′ against the bracket 150 by a bolt 152, which passes through an opening 154 in the bracket 150 and fastens to the plate 156. Embodiments of the bolts 134 and 152 may include any fastening device, such as a bolt, a screw, or a fastener.

The brackets 120 and 150 may be fastened together by a screw 160. The screw 160 attaches to the bracket 120 at a hole 126 and to the bracket 150 through a slot 158. The position of the screw 160 in the slot 158 may define the distance between the brackets 120 and 150. Thus, the rails 110a, 110b, 110a′, and 110b′ may be further secured against the neighboring teeth 105a and 105b by repositioning the screw 160 in the slot 158 and adjusting the distance between the brackets 120 and 150.

A collet 130 attaches to the bracket 120 via the bolt 134. The collet 130 is operable to receive a shaft 140, which may be attached to a cylinder 142. The shaft may be secured at any point within the collet 130. For example, in some embodiments, the shaft 140 may pass inside the collet 130 and potentially abut the bolt 134; in other embodiments, the shaft 140 may pass through the collet 130 and through a hole in the bolt 134.

The cylinder 142 may receive one or more cylindrical guides 144. The cylinder 142 and the cylindrical guides 144 may be operable to direct movement of the corresponding drill bit along a single drilling axis 170. In the embodiment illustrated in FIG. 2D, the cylindrical guides 144 may reside coaxially inside the cylinder 142. The interior diameter of each cylindrical guide 144 may correspond to the outer diameter of a drill bit. In some embodiments, a dentist may progressively enlarge the hole drilled in the open tooth socket by drilling a series of progressively larger holes using the cylindrical guides 144.

The cylinder 142 and the cylindrical guides 144 may be operable to define the distance at which a drill bit may enter into the tooth socket. For example, the cylinder 142 may be positioned to stop a drill at a specified point, thus defining the depth at which the drill bit may enter into the tooth socket.

Teachings of the embodiment illustrated in FIG. 2D recognize at least four mechanisms for adjusting the orientation of the drilling axis 170. First, the position of the bracket 120 may be established relative to the rails 110a and 110b. The measurement lines 114a and 114b measure the position of the bracket 120 relative to the rails 110a and 110b. Repositioning the bracket 120 along the rails 110a and 110b changes the position of the collet 130, the cylinder 142, and thus the drilling axis 170.

In addition, FIG. 2E illustrates three mechanisms for adjusting the drilling axis 170 relative to the bracket 120. First, the pitch of the collet 130 may be adjusted relative to the bracket 120 (“pitch 124A”). In FIG. 2D, the bracket 120 and the slotted plate 132 are curved. Thus, the position of the bolt 134 inside the opening 122 may define the pitch 124A. For example, in the embodiment illustrated in FIG. 2D, repositioning the bolt 134 away from the center of the opening 122 increases the pitch 124A. In this embodiment, the value of the pitch 124A may be measured by comparing measurement lines 124 and a reference line 138, which is positioned on a flat surface of the bolt 134.

Second, the rotation angle of the cylinder 142 may be adjusted relative to the collet 130 (“rotation angle 146A”). The shaft 140 may rotate inside the collet 130. The angle of this rotation (the rotation angle 146A) may be measured by reference to measurement lines 146 and/or the measurement line 138. Third, the radial distance of the cylinder 142 may be adjusted relative to the bracket 120 (“radial distance 148A”). The radial distance 148A may be adjusted by adjusting the depth of the shaft 140 inside the collet 130. The radial distance 148A may be measured by reference to measurement lines 148.

In the embodiment illustrated in FIGS. 2D and 2E, the measurement lines 146 are located at the end of the shaft 140 opposite the cylinder 142, and the measurement lines 146 are located at the end of the shaft 140 next to the cylinder 142. However, in other embodiments, the measurement lines 146 and 148 may be located in other positions, including overlapping to form a measurement grid on the shaft 140.

Teachings of the certain embodiments recognize that the dental implant guide 100 may be quickly removed from the cast of a human mouth and reinstalled in a human mouth without altering the measurements from the measurement lines 114a & 114b, 124, 146, and 148. For example, the screw 160 may be loosened; next, the dental implant guide 100 may be removed from the cast and placed in the human mouth; and finally, the screw 160 may be tightened, securing the dental implant guide 100 in the human mouth.

Teachings of certain embodiments recognize that the measurements from the measurement lines 114a & 114b, 124, 146, and 148 may be transferred between multiple dental implant guides 100. For example, a dentist could use a first dental implant guide 100 to calculate the measurements from the measurement lines 114a & 114b, 124, 146, and 148. The dentist could then submit these measurements to a surgeon, who could program the measurements into a second dental implant guide 100. Thus, although embodiments of the dental implant guide 100 can perform both radiographic and surgical functions, these functions can be separated among multiple dental implant guides 100.

Teachings of certain embodiments recognize that the dental implant guide 100 may provide faster readjustment than acrylic or thermoplastic surgical guides such as the surgical guide 10. If the positioning of the surgical guide 10 is incorrect, a new guide must be crafted. However, teachings of certain embodiments recognize that the dental implant guide 100 may be quickly adjusted by adjusting the measurements from the measurement lines 114a & 114b, 124, 146, and 148. Teachings of certain embodiments recognize that the dental implant guide 100 can also be used as an adjustable radiographic guide. The dentist may readjust the measurements from the measurement lines 114a & 114b, 124, 146, and 148; take a new x-ray; verify the orientation of the drilling axis 170; and repeat iterations of these steps until the drilling axis 170 is correct.

Teachings of certain embodiments also recognize the use of standardized tooth forms (e.g., incisor forms, molar forms, etc.) to predict heights and space requirements for implant placement. Standardized tooth forms may speed the iterative process of adjusting the dental implant guide 100 by providing initial, standardized measurements for the measurement lines 114a & 114b, 124, 146, and 148.

Teachings of certain embodiments recognize that the dental implant guide 100 may be utilized in connection with imaging systems such as CT scans, rapid prototyping, or computer-aided design/computer-aided manufacturing systems. For example, a dentist may use the results from a CT scan, such as a cone beam CT, of the dental implant guide 100 in a surgical planning software. Examples of the surgical planning software (listed according to software title name, company name, and company location) may include: Facilitate, Astra Tech Inc., Waltham, Mass.; Simplant, Materialise, Louven, Belgium; Procera 3-D Planning Software, Noble Biocare, Gotenborg, Sweeden. The surgical planning software may establish a planned orientation of the drilling axis 170 based on various conditions of the human mouth.

Embodiments of the dental implant guide 100 may be constructed out of any suitable material. For example, some embodiments of the dental implant guide 100 may be constructed out of metal. Teachings of certain embodiments recognize that a metal dental implant guide may provide durability, resiliency, and the capability to be sterilization. However, some embodiments may include components of any suitable material, such as plastics, composites, metals, or any suitable combination.

In addition, if the dentist intends to install more than one dental implant in a patient's mouth, the dentist would have to use more than one surgical guide 10. Each surgical guide 10 would be measured and oriented independently. If two dental implants are not precisely oriented in the same direction, the overall aesthetics and oral health of both dental implants may suffer. Accordingly, teachings of certain embodiments recognize the importance of recording the second dental implant's position in relation to the first dental implant in order to assure parallelism between different implants or record the angles between them.

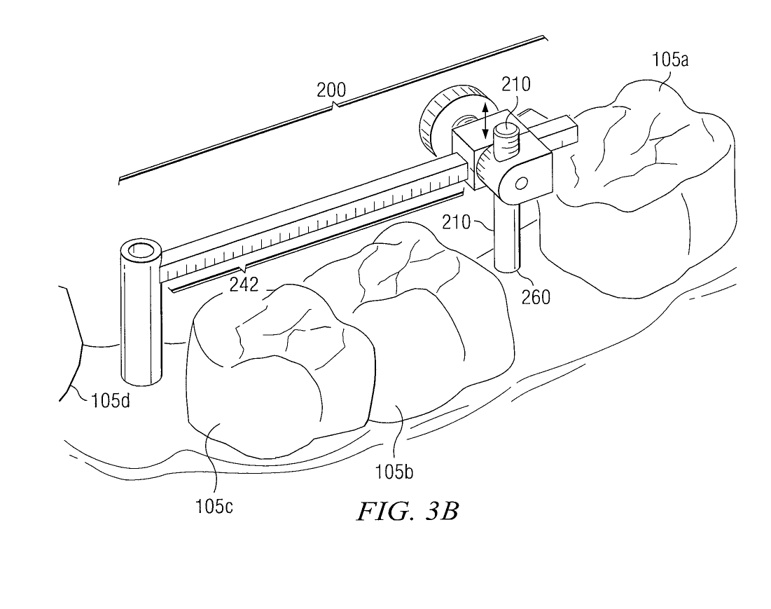

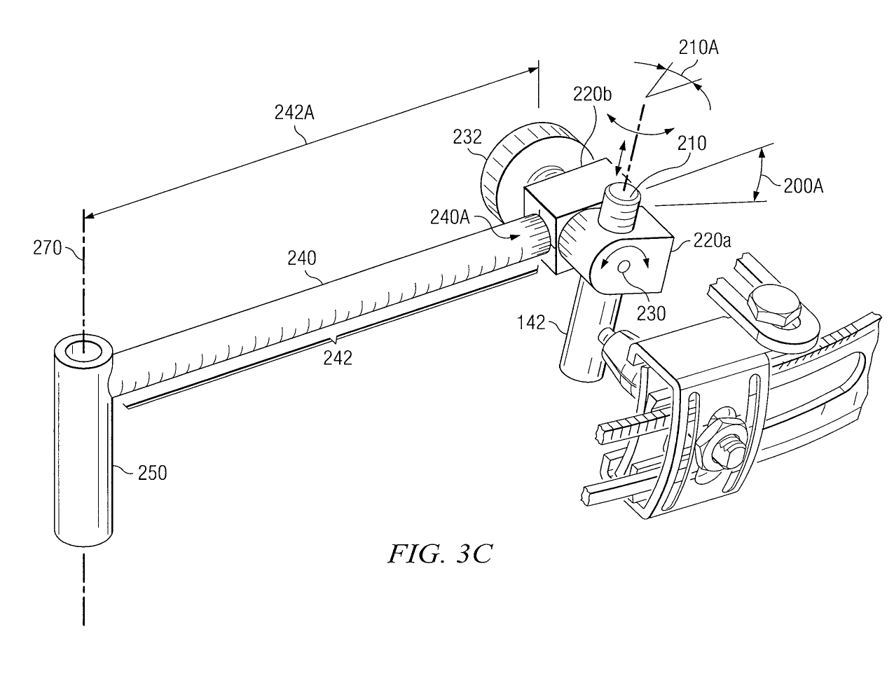

FIGS. 3A, 3B, and 3C present a dental implant guide extension 200 according to one embodiment. In the embodiment illustrated in FIG. 3A, the dental implant guide extension 200 connects to the dental implant guide 100 via a pin 210 that fits inside the cylinder 142. The pin 210 attaches to a base 220. The base 220 supports the remaining components of the dental implant guide extension 200.

A shaft 240 attaches to the base 220. In the embodiment illustrated in FIG. 3A, the shaft 240 is a circular shaft. However, embodiments of the shaft 240 are not limited to any particular geometry. For example, embodiments of the shaft 240 may be rectangular or circular.

The shaft 240 supports a cylinder 250. Similar to the cylinder 142, the cylinder 250 may receive one or more cylindrical guides, such as the cylindrical guides 144. The cylinder 250 and the cylindrical guides 144 are operable to direct movement of the corresponding drill bit along a single drilling axis 270.

The dental implant guide extension 200 is not limited to embodiments that connect to the dental implant guide 100. Rather, embodiments of the dental implant guide extension 200 may be secured using any suitable mechanism. FIG. 3B presents one example embodiment of the dental implant extension 200 secured to a human jaw. In the illustrated embodiment, the dental implant guide extension 200 connects to the human jaw via the pin 210 that fits inside a hole 260 in the human jaw. In one embodiment, the hole 260 may represent a pilot hole. In some embodiments, the hole 260 may be drilled using the dental implant guide 100. For example, the dental implant guide 100 may align the drilling axis 170; after the hole 260 is drilled, the dental implant guide 100 may be removed, and the dental implant guide extension 200 may be secured in the hole 260.

FIG. 3C illustrates four mechanisms for adjusting the drilling axis 270 relative to the cylinder 142. First, the pitch of the collet 130 may be adjusted relative to the bracket 120 (“pitch angle 200A”. The base 220 separates into blocks 220a and 220b. In the embodiment illustrated in FIG. 3A, block 220b can rotate relative to block 220a about an axle 230. Rotation of block 220b changes the pitch angle 200A by changing the pitch of the shaft 240, the cylinder 250, and thus the drilling axis 270. In some embodiments, the relative positions of the blocks 220a and 220b may be fixed by a tightening a retentive device, such as a thumbscrew 232. Some embodiments of the dental implant guide extension 200 may include measurement lines to measure the pitch angle 200A.

In some embodiments, the pitch angle 200A may be set such that the drilling axis 270 is parallel to the drilling axis 270 is parallel to the drilling axis 170. Teachings of certain embodiments recognize that defining the drilling axis 270 as parallel to the drilling axis 170 may improve the aesthetics of the dental implants. In addition, parallel dental implants may ease installation of a dental bridge between the two dental implants.

Second, the rotation angle of the pin 210 may be adjusted relative to the cylinder 142 (“rotation angle 210A”). The pin 210 may rotate inside the cylinder 142. In some embodiments, the position of the pin 210 inside the cylinder 142 may be fixed by tightening an additional retentive device, such as the thumbscrew 232. Some embodiments of the dental implant guide extension 200 may include measurement lines to measure the rotation angle 210A.

Third, the radial distance of the cylinder 250 may be adjusted relative to the block 220b (“distance 242A”). The distance 242A may be adjusted by adjusting the depth of the shaft 240 inside the block 220b. The distance 242A may be measured by reference to measurement lines 242. In some embodiments, the position of the shaft 240 inside the block 220b may be fixed by tightening an additional retentive device, such as the thumbscrew 232.

Fourth, in some embodiments, the rotation angle of the shaft 240 may be adjusted relative to the block 220b (“rotation angle 240A”). For example, in some embodiments, the shaft 240 may represent a circular shaft operable to rotate inside the block 220b. In some embodiments, the rotational position of the shaft 240 inside the block 220b may be fixed by tightening an additional retentive device, such as the thumbscrew 232.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke 6 of 35 U.S.C. § 112 as it exists on the date of filing hereof unless the words “means for” or “step for” are explicitly used in the particular claim.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. A dental implant guide system for installing multiple dental implants, comprising:
a dental implant guide, the dental implant guide operable to guide a first drill bit down a first drilling axis; and
a dental implant guide extension comprising:
a shaft adjustably attached to the dental implant guide; and
a drill guide attached to the shaft, the drill guide operable to guide the path of a second drill bit down a second drilling axis.

99. The dental implant guide system of claim 98, wherein the second drilling axis is operable to be adjusted in three dimensions relative to the first drilling axis.

100. The dental implant guide system of claim 98, the drill guide comprising:
an elongated cylinder operable to guide the path of the second drill bit down the second drilling axis; and
an additional cylinder operable to coaxially reside inside the elongated cylinder, the interior diameter of the additional cylinder corresponding to the outer diameter of the second drill bit.

101. The dental implant guide system of claim 98, further comprising:
a drill block attached to the shaft; and
a peg attaching the drill block to the dental implant guide, the peg providing rotational adjustment of the drill block relative to the dental implant guide.

102. The dental implant guide system of claim 101, further comprising measurement lines for measuring the rotational adjustment of the drill block about the peg.

103. The dental implant guide system of claim 98, further comprising:
a drill block attached to the shaft; and
an axle attaching the drill block to the dental implant guide, the axle providing pitch adjustment of the drill block relative to the dental implant guide.

104. The dental implant guide system of claim 103, further comprising measurement lines for measuring the pitch adjustment of the drill block about the axle.

105. The dental implant guide system of claim 98, further comprising:
a drill block attached to the dental implant guide; and
an opening in the drill block operable to receive the shaft, wherein the shaft is operable to be translationally adjusted inside the opening.

106. The dental implant guide system of claim 105, further comprising measurement lines for measuring the translational adjustment of the shaft.

107. The dental implant guide system of claim 98, wherein the second drilling axis is parallel to the first drilling axis.

108. A dental implant guide system comprising:
a drill base operable to be secured against one or more teeth inside of a human mouth; and
a drill guide adjustably attached to the drill base, the drill guide operable to guide the path of a drill bit down a drilling axis.

109. The dental implant guide system of claim 98, wherein the drilling axis is operable to be adjusted in three dimensions relative to the drill base.

110. The dental implant guide system of claim 109, the drill base comprising:
one or more rails; and
one or more tines attached to the one or more rails, the one or more tines operable to stabilize the one or more rails against the one or more teeth.

111. The dental implant guide system of claim 109, wherein the length of the rails may be adjusted to correspond to the distance between the one or more teeth.

112. The dental implant guide system of claim 111, the rails further comprising measurement lines for measuring the adjustment of the length of the rails.

113. The dental implant guide system of claim 110, further comprising a detachable crossbar operable to span a tooth socket opening and hold opposing rails together.

114. The dental implant guide system of claim 108, wherein:
the drill guide comprises:
an elongated cylinder operable to guide the path of the drill bit down the drilling axis, and
a shaft attached perpendicularly to the outside wall of the cylinder; and
the drill base comprises a collet operable to receive the shaft.

115. The dental implant guide system of claim 114, wherein the shaft is rotationally adjustable inside the collet.

116. The dental implant guide system of claim 115, further comprising measurement lines for measuring the rotational adjustment of the shaft inside the collet.

117. The dental implant guide system of claim 114, wherein the shaft is translationally adjustable inside the collet.

118. The dental implant guide system of claim 117, further comprising measurement lines for measuring the translational adjustment of the shaft inside the collet.

119. The dental implant guide system of claim 114, wherein the collet attaches to a curved bracket on the drill base, the curved bracket providing pitch adjustment of the collet.

120. The dental implant guide system of claim 119, further comprising measurement lines for measuring the pitch adjustment of the collet inside the curved bracket.

121. The dental implant guide system of claim 108, the drill guide comprising:
an elongated cylinder operable to guide the path of the drill bit down the drilling axis; and
an additional cylinder operable to coaxially reside inside the elongated cylinder, the interior diameter of the additional cylinder corresponding to the outer diameter of the drill bit.

122. The dental implant guide system of claim 108, further comprising a standardized tooth form, the standardized tooth form defining a set of initial measurements for the location of the drill guide.

123. The dental implant guide system of claim 108, further comprising:
a second shaft adjustably attached to the drill guide; and
a second drill guide attached to the second shaft, wherein the second drill guide is operable to guide the path of a second drill bit down a second drilling axis.

124. The dental implant guide system of claim 123, wherein the second drilling axis is operable to be adjusted in three dimensions relative to the drilling axis.

125. The dental implant guide system of claim 123, the second drill guide comprising:
an elongated cylinder operable to guide the path of the second drill bit down the second drilling axis; and
an additional cylinder operable to coaxially reside inside the elongated cylinder, the interior diameter of the additional cylinder corresponding to the outer diameter of the second drill bit.

126. The dental implant guide system of claim 123, further comprising:
a drill block attached to the second shaft; and
a peg attaching the drill block to the drill guide, the peg providing rotational adjustment of the drill block relative to the drill guide.

127. The dental implant guide system of claim 126, further comprising measurement lines for measuring the rotational adjustment of the drill block about the peg.

128. The dental implant guide system of claim 123, further comprising:
a drill block attached to the second shaft; and
an axle attaching the drill block to the drill guide, the axle providing pitch adjustment of the drill block relative to the drill guide.

129. The dental implant guide system of claim 128, further comprising measurement lines for measuring the pitch adjustment of the drill block about the axle.

130. The dental implant guide system of claim 123, further comprising:
a drill block attached to the drill guide; and
an opening in the drill block operable to receive the second shaft, wherein the second shaft is operable to be translationally adjusted inside the opening.

131. The dental implant guide system of claim 130, further comprising measurement lines for measuring the translational adjustment of the second shaft.

132. The dental implant guide system of claim 123, wherein the second drilling axis is parallel to the first drilling axis.

133. A method for installing a dental implant, comprising:
securing a dental implant guide against one or more teeth in a human mouth; and
configuring the dental implant guide to guide a drill bit along a drilling axis, the dental implant guide comprising:
a drill base operable to be secured against the one or more teeth; and
a drill guide adjustably attached to the drill base, the drill guide operable to guide the path of the drill bit down the drilling axis.

134. The method of claim 133, the drill base comprising:
one or more rails; and
one or more tines attached to the one or more rails, the one or more tines operable to stabilize the one or more rails against the one or more teeth.

135. The method of claim 134, further comprising adjusting the length of the rails to correspond to the distance between the one or more teeth.

136. The method of claim 135, the rails further comprising measurement lines for measuring the adjustment of the length of the rails.

137. The method of claim 134, the dental implant guide further comprising a detachable crossbar operable to span a tooth socket opening and hold opposing rails together.

138. The method of claim 133, wherein the configuring the dental implant guide to guide a drill bit along a specified drilling axis comprises adjusting the drill guide in three dimensions relative to the drill base.

139. The method of claim 133, wherein:
the drill guide comprises:
an elongated cylinder operable to guide the path of the drill bit down the drilling axis,
and a shaft attached perpendicularly to the outside wall of the cylinder; and
the drill base further comprises a collet operable to hold the shaft.

140. The method of claim 139, wherein the configuring the dental implant guide to guide a drill bit along a drilling axis comprises adjusting the rotation of the shaft inside the collet.

141. The method of claim 140, the dental implant guide further comprising measurement lines for measuring the rotational adjustment of the shaft inside the collet.

142. The method of claim 139, wherein the configuring the dental implant guide to guide a drill bit along a drilling axis comprises adjusting the translational position of the shaft inside the collet.

143. The method of claim 142, the dental implant guide further comprising measurement lines for measuring the translational adjustment of the shaft inside the collet.

144. The method of claim 139, wherein:
the collet is attached to a curved bracket on the drill base; and
the configuring the dental implant guide to guide a drill bit along a drilling axis comprises adjusting the pitch of the collet inside the curved bracket.

145. The method of claim 144, further comprising measurement lines for measuring the pitch adjustment of the collet inside the curved bracket.

146. The method of claim 133, the drill guide further comprising an elongated cylinder operable to guide the path of the drill bit down the drilling axis, the method further comprising:
selecting an additional cylinder operable to coaxially reside inside the elongated cylinder, the interior diameter of the additional cylinder corresponding to the outer diameter of the drill bit.

147. The method of claim 133, wherein the configuring the dental implant guide to guide a drill bit along a drilling axis comprises:
selecting a standardized tooth form corresponding to a dental implant, the standardized tooth form defining a set of initial measurements for the location of the drill guide; and
pre-adjusting the dental implant guide based on the set of initial measurements.

148. The method of claim 133, wherein the configuring the dental implant guide to guide a drill bit along a drilling axis comprises:
installing the dental implant guide in a cast of the human mouth;
configuring the orientation of the drilling axis inside the cast of the human mouth; and
reinstalling the dental implant guide in the human mouth.

149. The method of claim 148, further comprising verifying the orientation of the drilling axis with an image of the dental implant guide installed in the cast of the human mouth.

150. The method of claim 149, wherein the image is a radiographic image.

151. The method of claim 149, wherein the image is a CT scan image.

152. The method of claim 133, wherein the configuring the dental implant guide to guide a drill bit along a drilling axis comprises:
consulting a surgical planning software program, the surgical planning software program operable to define the orientation of the drilling axis.

153. The method of claim 133, further comprising:
attaching a dental implant guide extension to the dental implant guide, wherein the dental implant guide extension comprises:
a second shaft adjustably attached to the drill guide; and
a second drill guide attached to the second shaft, the second drill guide operable to guide the path of a second drill bit down a second drilling axis.

154. The method of claim 153, further comprising
installing the dental implant guide and the dental implant guide extension in a cast of the human mouth;
configuring the orientation of the drilling axis and the second drilling axis inside the cast of the human mouth; and
reinstalling the dental implant guide and the dental implant guide extension in the human mouth.

155. The method of claim 154, further comprising verifying the orientation of the second drilling axis with an image of the dental implant guide installed in the cast of the human mouth.

156. The method of claim 155, wherein the image is a radiographic image.

157. The method of claim 155, wherein the image is a CT scan image.

158. The method of claim 153, further comprising adjusting the second drilling axis in three dimensions relative to the drilling axis.

159. The method of claim 153, the second drill guide comprising an elongated cylinder operable to guide the path of the second drill bit down the second drilling axis, the method further comprising selecting an additional cylinder operable to coaxially reside inside the elongated cylinder, the interior diameter of the additional cylinder corresponding to the outer diameter of the second drill bit.

160. The method of claim 153, the second drill guide comprising:
a drill block attached to the second shaft; and
a peg attaching the drill block to the drill guide, the peg providing rotational adjustment of the drill block relative to the drill guide.

161. The method of claim 160, the second drill guide further comprising measurement lines for measuring the rotational adjustment of the drill block about the peg.

162. The method of claim 153, the second drill guide comprising:
a drill block attached to the second shaft; and
an axle attaching the drill block to the drill guide, the axle providing pitch adjustment of the drill block relative to the drill guide.

163. The method of claim 162, the second drill guide further comprising measurement lines for measuring the pitch adjustment of the drill block about the axle.

164. The method of claim 153, the second drill guide comprising:
a drill block attached to the drill guide; and
an opening in the drill block operable to receive the second shaft, wherein the second shaft is operable to be translationally adjusted inside the opening.

165. The method of claim 164, the second drill guide further comprising measurement lines for measuring the translational adjustment of the second shaft.

166. The method of claim 153, wherein the second drilling axis is parallel to the first drilling axis.

167. A method for installing a dental implant, comprising:
installing a dental implant guide inside a human mouth, the dental implant guide operable to guide a first drill bit down a first drilling axis; and
attaching a dental implant guide extension to the dental implant guide, the dental implant guide extension comprising:
a shaft adjustably attached to the dental implant guide; and
a drill guide attached to the shaft, the drill guide operable to guide the path of a second drill bit down a second drilling axis.

168. The method of claim 167, further comprising adjusting the second drilling axis in three dimensions relative to the first drilling axis.

169. The method of claim 167, the drill guide comprising an elongated cylinder operable to guide the path of the second drill bit down the second drilling axis, the method further comprising:
selecting an additional cylinder operable to coaxially reside inside the elongated cylinder, the interior diameter of the additional cylinder corresponding to the outer diameter of the second drill bit.

170. The method of claim 167, the dental implant guide extension further comprising:
a drill block attached to the shaft; and
a peg attaching the drill block to the dental implant guide, the peg providing rotational adjustment of the drill block relative to the dental implant guide.

171. The method of claim 170, the dental implant guide extension further comprising measurement lines for measuring the rotational adjustment about the peg.

172. The method of claim 167, the dental implant guide extension further comprising:
a drill block attached to the shaft; and
an axle attaching the drill block to the dental implant guide, the axle providing pitch adjustment of the drill block relative to the dental implant guide.

173. The method of claim 172, the dental implant guide extension further comprising measurement lines for measuring the pitch adjustment of the shaft about the axle.

174. The method of claim 167, the dental implant guide extension further comprising:
a drill block attached to the dental implant guide; and
an opening in the drill block operable to receive the shaft, wherein the shaft is operable to be translationally adjusted inside the opening.

175. The method of claim 174, the dental implant guide extension further comprising measurement lines for measuring the translational adjustment of the shaft.

176. The method of claim 167, further comprising adjusting the dental implant guide extension such that the second drilling axis is parallel to the first drilling axis.

177. The method of claim 168, wherein the adjusting the second drilling axis in three dimensions relative to the dental implant guide comprises:
selecting a standardized tooth form corresponding to a dental implant, the standardized tooth form defining a set of initial measurements for the location of the drill guide; and
pre-adjusting the dental implant guide extension based on the set of initial measurements.

178. The method of claim 167, further comprising:
installing the dental implant guide and the dental implant guide extension in a cast of the human mouth;
configuring the orientation of the first drilling axis and the second drilling axis inside the cast of the human mouth; and
reinstalling the dental implant guide and the dental implant guide extension in the human mouth.

179. The method of claim 178, further comprising verifying the orientation of the second drilling axis with an image of the dental implant guide extension installed in the cast of the human mouth.

180. The method of claim 179, wherein the image is a radiographic image.

181. The method of claim 179, wherein the image is a CT scan image.

182. The method of claim 167, further comprising:
installing a second dental implant guide and a second dental implant guide extension in a cast of the human mouth, wherein the second dental implant guide extension is operable to guide the path of a second drill bit down the second drilling axis;
configuring the orientation of the second drilling axis of the second dental implant guide extension inside the cast of the human mouth;
measuring the orientation of the second drilling axis of the second dental implant guide extension inside the cast of the human mouth; and
configuring the dental implant guide extension in the human mouth based on the measurements of the orientation of the second drilling axis of the second dental implant guide extension inside the cast of the human mouth.

183. The method of claim 182, further comprising verifying the orientation of the second drilling axis with an image of the second dental implant guide extension installed in the cast of the human mouth.

184. The method of claim 183, wherein the image is a radiographic image.

185. The method of claim 183, wherein the image is a CT scan image.

186. The method of claim 178, wherein the adjusting the second drilling axis in three dimensions relative to the dental implant guide comprises consulting a surgical planning software program, the surgical planning software program operable to define the orientation of the drilling axis.
